(19) United States
(12) Patent Application Publication
(10) Pub. No.: US 2023/0002970 A1
(43) Pub. Date: Jan. 5, 2023

(54) MACHINE, PARTICULARLY FOR PRODUCING CELLULOSE FIBER FROM WASTE PAPER

(71) Applicant: Paolo REBAI, Como (IT)

(72) Inventor: Paolo REBAI, Como (IT)

(21) Appl. No.: 17/684,577

(22) Filed: Mar. 2, 2022

(30) Foreign Application Priority Data
Mar. 30, 2021 (IT) 102021000007766

(51) Int. Cl. D21B 1/08; B02C 13/18; B02C 13/282; B02C 13/286; B02C 13/288

(52) U.S. Cl. CPC D21B 1/08; B02C 13/185; B02C 13/282; B02C 13/286; B02C 13/288; B02C 2013/28654; B02C 2201/06

(57) ABSTRACT

A machine, particularly for producing cellulose fiber from waste paper with characteristics and yield comparable to virgin fiber, includes
at least one conveyor body which is adapted to receive the waste material from which to obtain cellulose fiber;
and at least one drum which contains inside it grinders adapted to grind the waste material for the production of the cellulose fiber, and which communicates with the conveyor body.

The grinders include a grinding hammer which is arranged on the bottom of the drum and can rotate by way of a motor about a rotation axis.

### CROSS-REFERENCED TO RELATED APPLICATIONS

This application is related to and claims the benefit of Italian Patent Application No. 102021000007766, filed on Mar. 30, 2021, the contents of which are herein incorporated by reference in their entirety.

### TECHNICAL FIELD

The present disclosure relates to a machine, particularly for producing cellulose fiber from waste paper, with characteristics and yield comparable to virgin fiber.

### BACKGROUND

In the sector of recycling waste paper and cardboard, in recent years in some countries increasingly stringent regulations have been introduced which require the almost total absence of non-cellulose materials in recycled paper.

These restrictions have created considerable difficulties, both for exporters who are unable to have materials that comply with the regulations, and for paper mills which purchase waste paper and cardboard in large volumes from the latter, especially in imports and exports.

In fact, with the new limits, especially in the Chinese market, waste paper import licenses have almost disappeared and the market in some sectors in China is now suffering a major shortage of raw material.

In other words, the market demand of these sectors in China is now geared to contaminant-free paper and cardboard, but also to quality paper pulp.

### SUMMARY

The aim of the present disclosure is to provide a machine capable of converting waste paper and cardboard to cellulose fiber with characteristics equal to virgin fiber.

Within this aim, the present disclosure provides a machine for converting paper and cardboard, the product of which is eco-sustainable and has the same yield as virgin fiber.

The present disclosure further provides a machine for converting paper and cardboard, the product of which is free from humidity, is stable over time and does not undergo alterations as a result of shipping, and no longer resembles waste paper, but a fiber.

The present disclosure also provides a machine for converting paper and cardboard to cellulose fiber that is capable of offering the widest guarantees of reliability and safety in use.

Last but not least, the present disclosure provides a machine for converting paper and cardboard to cellulose fiber that can be provided with technologies that are known per se and which therefore is of low cost.

This aim and these and other advantages which will become better apparent hereinafter are achieved by providing a machine, particularly for producing cellulose fiber from waste paper, which comprises:
at least one conveyor body which is adapted to receive the waste material from which to obtain cellulose fiber; and
at least one drum which contains inside it grinding means adapted to grind said waste material for the production of said cellulose fiber; said drum communicating with said at least one conveyor body;

characterized in that said grinding means comprise a grinding hammer which is arranged on the bottom of said drum and can rotate by way of motor means about a rotation axis.

### BRIEF DESCRIPTION OF THE DRAWINGS

Further characteristics and advantages of the disclosure will become better apparent from the detailed description of a preferred, but not exclusive, embodiment of a machine, particularly for producing cellulose fiber from waste paper, illustrated by way of non-limiting example with the aid of the accompanying drawings wherein:

FIG. 1 is a perspective view of the machine according to the present disclosure;

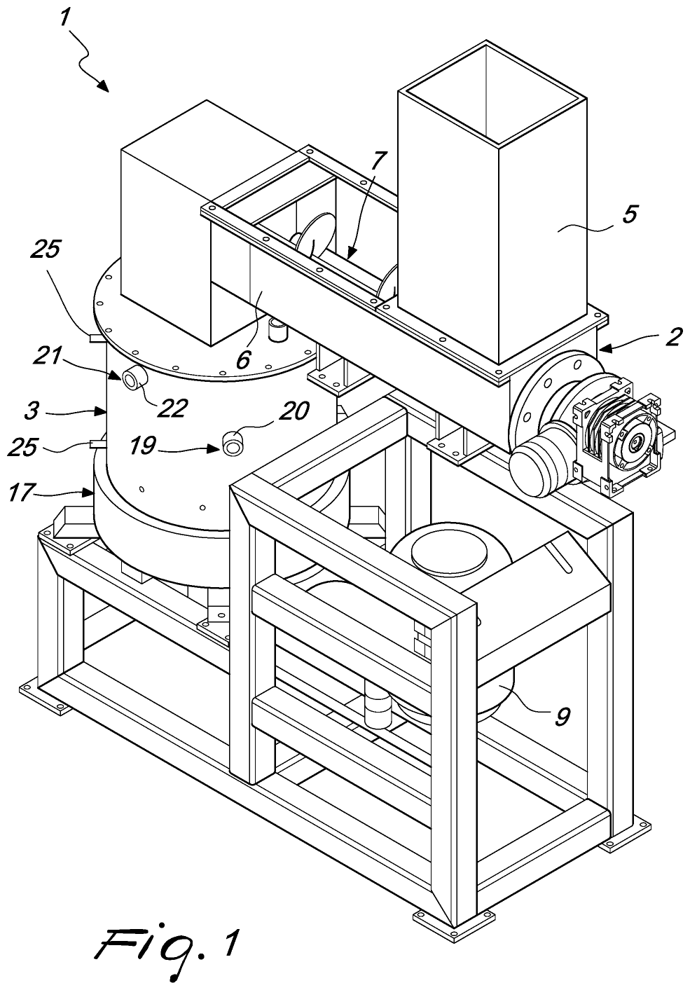

FIG. 2 is a side view of the machine shown in FIG. 1;

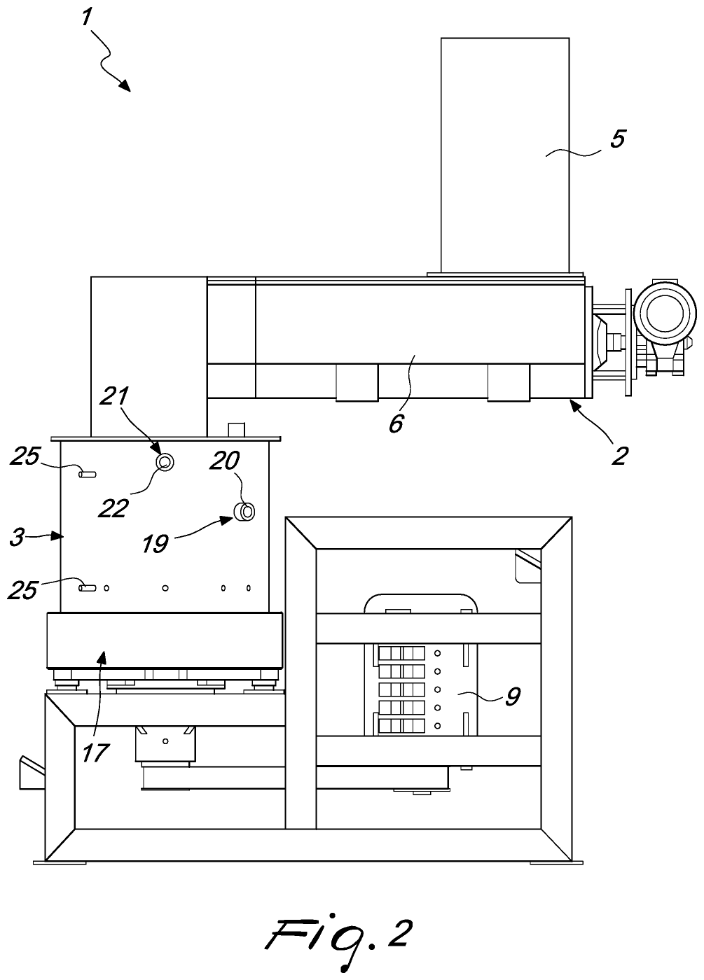

FIG. 3 is a plan view from above of the machine shown in the previous figures;

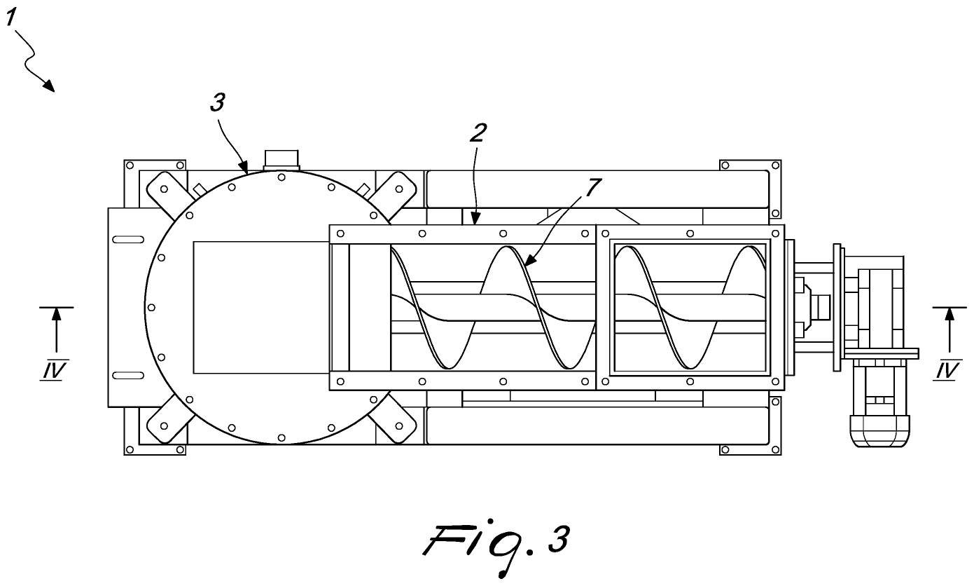

FIG. 4 is a cross-sectional view of the machine shown in the previous figures and taken along the line Iv-Iv shown in FIG. 3;

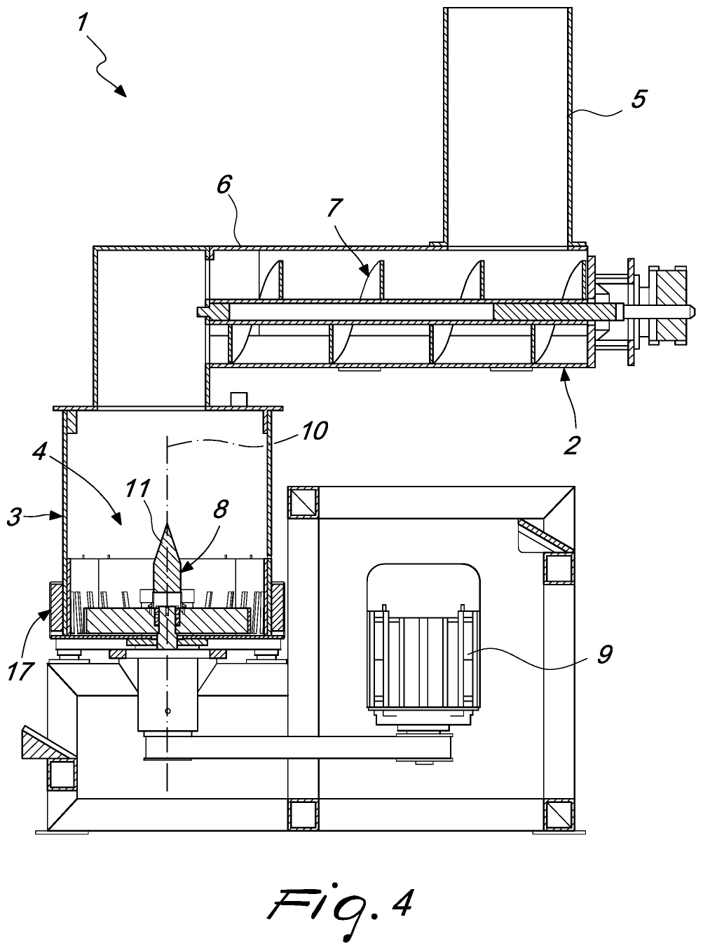

FIG. 5 is an enlarged-scale detail of the machine shown in FIG. 4;

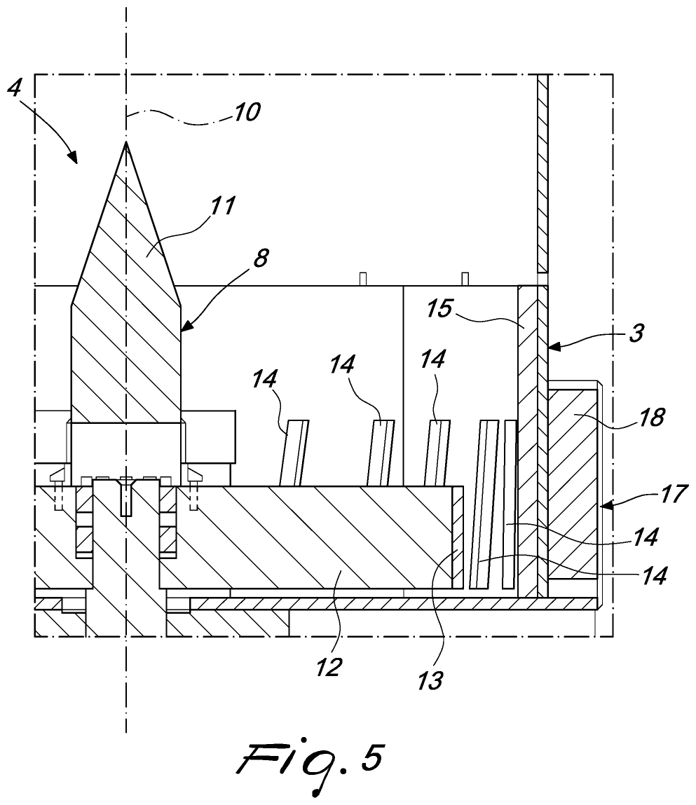

FIGS. 6 and 7 are two perspective views, respectively, of two components of the machine shown in the previous figures;

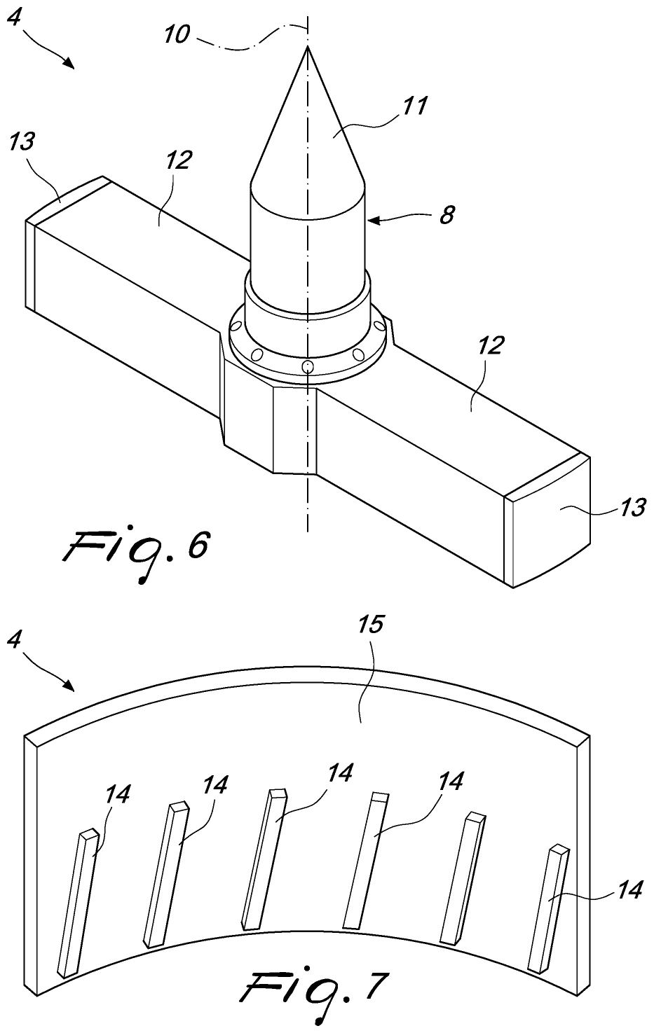

FIG. 8 is a partially exploded plan view from above of the machine shown in the previous figures; and

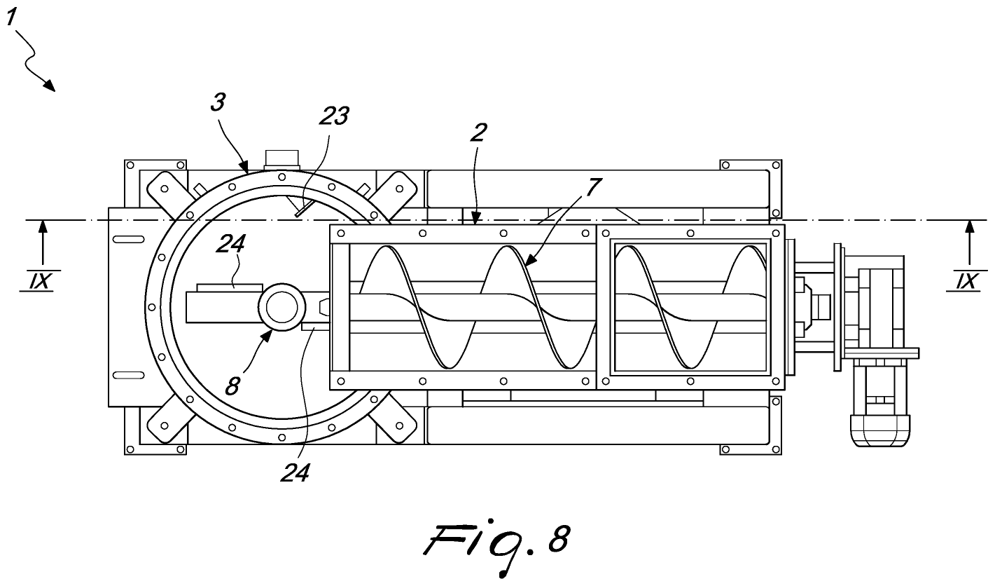

FIG. 9 is a cross-sectional view of the machine shown in the previous figures and taken along the line IX-IX shown in FIG. 8.

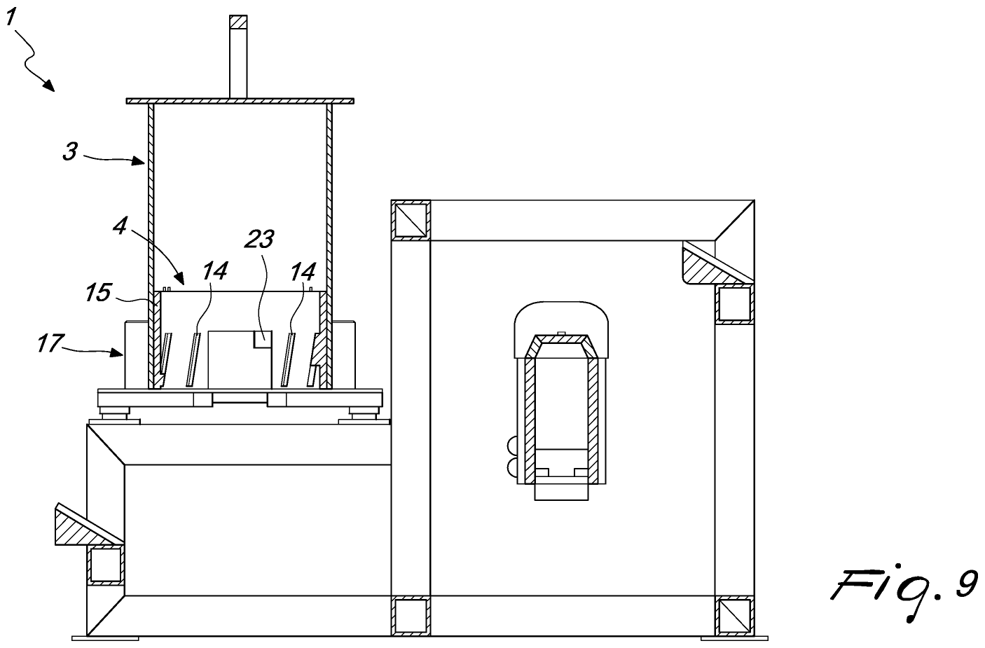

### DETAILED DESCRIPTION OF THE DRAWINGS

With reference to the figures, the machine according to the disclosure, particularly for producing cellulose fiber from waste paper, generally designated with the reference numeral 1, comprises at least one conveyor body 2 which is adapted to receive waste material, such as paper, cardboard and the like, from which to obtain cellulose fiber and at least one drum 3 which contains inside it grinding means 4 adapted to grind the waste material for the production of cellulose fiber.

In more detail, the conveyor body 2, which is connected to the drum 3, comprises a first, vertical portion 5 into which the waste material is loaded by gravity and a second, horizontal portion 6 which is consecutive to the first, vertical portion 5 along the advancement direction of the waste material and contains inside it a motorized screw feeder 7 for the controlled and uniform advancement of the waste material.

Conveniently, the second, horizontal portion 6 ends, along the advancement direction of the waste material, with an open section that lies above the drum 3 for the falling by gravity of the waste material into the drum 3.

With regard to the drum 3, this can be made of carbon steel (and therefore can be executed in wear-resistant material) or of stainless steel.

Based on the level of humidity of the material fed in, it may be necessary to have smooth or mirrored surfaces in the drum with no sharp corners smaller than 90°, but with rounded corners, in order to prevent packing of the material and/or the snagging and buildup thereof in unwanted areas.

The drum 3 can also be covered internally with ceramic to minimize the packing effect described above.

According to the disclosure, the grinding means 4 comprise a grinding hammer 8 which is arranged on the bottom of the drum 3 and can rotate by way of motor means 9 about a rotation axis 10 which is oriented substantially parallel to the direction of falling of the waste material from the conveyor body 2.

More specifically, the grinding hammer 8 comprises a conical body 11 that extends along the rotation axis 10 and with the vertex directed toward the conveyor body 2 for the breakup of the falling waste material, and comprises at least two mauls 12 which are mutually opposite with respect to the rotation axis 10 and are adapted to strike the waste material with consequent grinding thereof.

Advantageously, such mauls 12 are provided with wear-prevention inserts 13 of the removable type.

Moreover, the grinding means 4 comprise a plurality of fixed slats 14 which are associated with the side walls of the drum 3 peripherally to the workspace of the grinding hammer 8 for a further grinding of the waste material.

In more detail, the fixed slats 14, which are associated with at least two wear-prevention sectors 15 which are removably associated with the side walls of the drum 3, can be arranged in an inclined manner and at a controlled distance from the grinding hammer 3.

A larger number of fixed slats 14 entails a greater friction for the grinding, therefore the individual sector can contain more or fewer of them.

The sectors in the drum can number from two to six, as many as necessary to cover the drum for 360°. The sectors can be easily replaced in that they are anchored mechanically inside it, but also by screws located outside the drum 3.

The following complete the machine 1:
cooling means 17 for the drum 3, which include for example a water-cooled chamber 18 arranged outside the base of the drum 3 at the fixed slats 14;
venting means 19 for the steam generated in the drum 3, which comprise venting pipes 20;
fire-prevention means 21 for the drum 3, which comprise a water spray nozzle 22.

Advantageously, in order to reduce retention time and, as a consequence, to increase production capacity, fixed baffles 23 can be provided which are associated with the drum 3 in the upper part thereof and/or movable baffles 24 can be provided which are arranged above the grinding hammer 8, such as to facilitate the fall of the waste material over the grinding hammer 8 so that such material is brought more easily to the grinding zone i.e. between the mauls 12 and the fixed slats 14.

In the same way, in order to facilitate the output of the material from the exit port, further baffles can be positioned.

The baffles 23 and 24 can be made of wear-resistant material or of stainless steel.

The operation of the machine 1 according to the disclosure is described below.

The waste material, which as mentioned previously can comprise paper, cardboard and the like, is loaded from above into the conveyor body 2 and, by way of the motorized screw feeder 7, is dosed into the drum 3.

The grinding hammer 8, in rotation about its own rotation axis 10 at a speed controlled by an inverter, carries out its grinding action on the lower wall of the drum 3 and the grinding action is accentuated by the fixed slats 14.

The thickness, the size and the design of these slats can vary in order to increase or diminish the grinding action created between slat and hammer.

In more detail, the grinding hammer 8 can rotate at low RPM while the screw feeder 7 doses the desired quantity of material in input.

Once the loading is finished, the grinding hammer 8 can increase the RPM until it reaches its maximum and it remains at this speed for a determined length of time, which can be set, and which is necessary to reach the desired degree of grinding, which can also be an intermediate stage if there are multiple drums in a cascade configuration.

In such case, the number of slats per sector can vary in order to obtain a more or less marked grinding activity, in this manner, for the same retention time, each drum in sequence will exert a greater or lesser friction and grinding. This is due to the number of impacts of the grinding hammer 8 on the slats at each turn.

Subsequently the grinding hammer 8 can decrease the RPM, also to allow the material to sink fully into the lower part of the drum where in the meantime the exit port arranged in the lower part of the drum 3 is opened and allows the material to exit.

The grinding action produces heat which is dissipated through the chamber 18 arranged outside the base of the drum 3 at the slats 14.

Any steam that may be created in the drum 3 is evacuated through venting pipes 20 located in its upper part.

As mentioned previously, the grinding hammer 8 rotates at a distance from the fixed slats 14 that varies based on the dimensions of the mauls 12. That is to say, the length of the grinding hammer is smaller than the diameter that is measured on the innermost end of the fixed slats 14, leaving an amount of play which can oscillate from 1 millimeter up to 60 millimeters.

In order to contain the costs of wear, the grinding hammer 8 is provided with easily replaceable and removable wear-prevention inserts 13; this furthermore makes it possible to reduce machine shutdown times and running costs.

The grinding hammer 8 with its removable wear-prevention inserts 13 can also be prepared on a bench for a faster replacement.

The rotation of the grinding hammer 8 and the inclination of the fixed slats 14 ensure that the material is projected upward and falls back down toward the bottom, in the most central zone, creating a rotational vortex.

Since the material is light, its natural rotation created by the above mentioned vortex tends to make the material stay in the upper part, as a consequence increasing the retention time necessary for full grinding.

Since the specific weight of the broken-up cardboard is higher than the specific weight of the cellulose fiber produced, it becomes necessary to have a drum 3 with a volume such that it will be reasonably filled with the lighter material. This is why it is necessary to feed broken-up cardboard for approximately half of the volume that is necessary to contain the same weight of cellulose fiber.

The material exits by centrifugal force and, by way of a screw feeder or with a conveyor belt, is lifted to be taken away or to be fed to a second drum, then optionally a third drum and even a fourth drum.

The number of drums determines the processing capacity of the system in that for the same retention time and, as a consequence, for the process, the system makes it possible to require a shorter time to load the same quantity.

It follows from this that for the same retention time, two drums produce double the amount of one, three drums triple the amount and so on.

The sequence of multiple drums makes it possible to convert the process from a batch process to a continuous or semi-continuous process.

The retention time varies from 10 to 180 seconds as a function of the different types of material to be processed, its size range for feeding, and the degree of grinding it is desired to obtain.

The process is monitored by temperature and pressure sensors 25 (these are generated by the humidity of the material which is converted to steam) located inside the drum 3.

The data are constantly read by a PLC system that monitors the steps of the process. The process can be managed manually or automatically.

At the end of the process, the material is unloaded from the machine 1 to be sent to the subsequent processing steps such as for example pressing in order to reduce its volume and optimize its transport.

The compaction press can be of the horizontal type typically used for paper, cardboard or waste in general, with binding with metallic or plastic filaments and/or covering with film.

Compaction is also possible with vertical presses in order to form bales which are contained in heat-shrunk bags or covered in film, as occurs in the pressing of peat or of topsoil.

The size range for feeding can be at most 200 millimeters and the finer the size range, the greater will be the yield of the plant and its production capacity.

The humidity of the waste material must be less than 20%.

The machine 1 can accept paper and cardboard, with a maximum 15% of unwanted materials like plastics, inert materials, wood, textiles or glue, which are typical of contamination from broken-up separated waste originating from different sources.

In fact, the permitted tolerance of contaminant materials is 15%, of which materials that are dangerous to the system (like stones, metals, wood with a maximum size range of 30 millimeters) cannot exceed 2%.

In practice it has been found that the machine according to the disclosure, particularly for producing cellulose fiber from waste paper, achieves the intended aim and objects in that it makes it possible to obtain cellulose fiber while increasing productive efficiency in the step of pulping in paper mills by 15/25%, in that the time/cycle of the pulper is reduced by these percentages as an effect of having fed in a material that is already in the fibrous state and not in the solid state, like cardboard.

The consequence of this reduction of time and the less effort required to dissolve the cardboard in water is an energy saving of 10-20%.

In fact, the ground-down product obtained is dry by virtue of the evaporation of water and the residual humidity close to 0%, and the appearance of the material in output is no longer recognizable as that of the cardboard in input.

In other words, the machine according to the disclosure makes it possible to obtain cellulose fiber from the mechanical grinding of paper and cardboard in the absence of water. During the process the material changes appearance and characteristics because it is converted to cellulose fiber with properties similar to those of virgin cellulose fiber.

By virtue of the grinding hammer, which is not a shredder that cuts the material, but a grinder, it is possible to separate the fibers of cellulose, leaving them in their original length.

Moreover, the paper fiber obtained from the machine according to the present disclosure can be used with optimal yields in different areas.

For example, this paper fiber can be used in paper mills for recycling, in which this represents a quality raw material.

This characteristic makes it possible for the paper fiber to be exported to those countries that in recent years have imposed strict limits on the characteristics of paper and cardboard for recycling.

Moreover, the paper fiber obtained from the machine according to the present disclosure can be used for the production of substrates and topsoil.

In fact, since the paper fiber is a light material, this is capable of retaining water and it is also sustainable and easily mixed with other components of substrates like peat, wood fiber, rice husks, perlite, compost or sawdust, and it can be used in the blends that make up topsoil and substrates for cultivation.

Paper fiber is not phytotoxic and it can be sold loose or in bags.

Finally, the paper fiber obtained from the machine according to the present disclosure can also be used as an absorbent material for industrial spills, both of liquids and of sludge.

The characteristics of lightness and porosity enable the paper fiber to absorb liquid or doughy materials using small amounts of material, which will then need to be disposed of subsequently together with the absorbed contaminant.

In this case too, paper fiber can be sold loose or in bags.

The machine is also capable of grinding other, different materials, taken individually or variously mixed together, such as wood, straw, brushwood, discarded material from pruning, and other organic discarded materials suitably broken down.

The machine, particularly for producing cellulose fiber from waste paper, thus conceived, is susceptible of numerous modifications and variations, all of which are within the scope of the appended claims.

Moreover, all the details may be substituted by other, technically equivalent elements.

For example, the shape of the grinding hammer, and also the volume of the drum, can have different shapes and volumes in order to adapt to the varying of the specific weight of the material and as a consequence of the volume to be processed in the drum and of the grinding action that occurs between the grinding hammer and the slats arranged at the base of the drum.

In practice the materials employed, provided they are compatible with the specific use, and the contingent dimensions and shapes, may be any according to requirements.

1. A machine for producing cellulose fiber from waste paper, said machine comprises:
at least one conveyor body which is adapted to receive a waste material from which to obtain cellulose fiber; and
at least one drum containings grinding means adapted to grind said waste material for the production of said cellulose fiber; said drum communicating with said at least one conveyor body;
wherein said grinding means comprise a grinding hammer which is arranged on a bottom of said drum and is configured to rotate by motor means about a rotation axis.

2. The machine according to claim 1, wherein said at least one conveyor body comprises a first, vertical portion configured for loading by gravity of said waste material and a second, horizontal portion which is consecutive to said first, vertical portion along an advancement direction of said waste material and contains inside said second, horizontal portion a motorized screw feeder for a controlled and uniform advancement of said waste material; said second, horizontal portion ending along said advancement direction of said waste material with an open section that lies above said drum for falling by gravity of said waste material into said drum.

3. The machine according to claim 1, wherein said grinding hammer comprises at least two mauls disposed mutually opposite with respect to said rotation axis and are adapted to strike said waste material with consequent grinding of said waste material.

4. The machine according to claim 1, wherein said rotation axis is oriented substantially parallel to a direction of falling of said waste material from said at least one conveyor body and wherein said grinding hammer comprises a conical body that extends along said rotation axis and with a vertex directed toward said at least one conveyor body for breakup of said falling waste material.

5. The machine according to claim 3, wherein said mauls are provided with at least one removable wear-prevention insert.

6. The machine according to claim 1, wherein said grinding means comprise a plurality of fixed slats which are associated with side walls of said drum peripherally to a workspace of said grinding hammer for a further grinding of said waste material; said fixed slats being arranged in an inclined manner and at a controlled distance from said grinding hammer.

7. The machine according to claim 6, wherein said fixed slats are associated with at least two removable wear-prevention sectors associated with said side walls.

8. The machine according to claim 1, further comprising at least one from among cooling means for said drum, venting means for steam generated in said drum, and fire-prevention means for said drum.

9. The machine according to claim 1, further comprising baffles which are associated with either or both of said drum and said grinding hammer configured to reduce a retention time of said waste material and increase a production capacity.
